(19) United States
(12) Patent Application Publication
(10) Pub. No.: US 2013/0144536 A1
(43) Pub. Date: Jun. 6, 2013

(54) Medical Device with Wireless Communication Bus

(71) Applicants: Steven D. Baker, Beaverton, OR (US); Robert J. Kahlke, Milwaukie, OR (US); Karen S. Hendricks, Big Pine Key, FL (US)

(72) Inventors: Steven D. Baker, Beaverton, OR (US); Robert J. Kahlke, Milwaukie, OR (US); Karen S. Hendricks, Big Pine Key, FL (US)

(73) Assignee: WELCH ALLYN, INC., Skaneateles Falls, NY (US)

(21) Appl. No.: 13/312,674

(22) Filed: Dec. 6, 2011

(51) Int. Cl. G06F 19/00; H04B 7/24

(52) U.S. Cl. 702/19; 455/39

(57) ABSTRACT

A medical device includes an internal wireless communication bus. The medical device comprises a first physiological sensor device comprising a first radio. The medical device further comprises a patient monitor device comprising a second radio. The medical device is configured to establish an internal wireless communication between the first radio and the second radio using the internal wireless communication bus.

### BACKGROUND

In medical applications, some medical devices, for example physiological sensor devices, may need to communicate directly with other medical devices. For example, in signal averaged oscillometry (SAO), performance is improved when an ECG sensor device can communicate directly with a non-invasive blood pressure (NIBP) sensor device, particularly in a high noise environment.

Medical devices are also required to provide electrical isolation as a part of patient safety. However, providing electrical isolation for medical devices, typically in the form of a hardware isolation module, can be expensive. Wireless physiological sensor devices may sometimes be used to provide electrical isolation at a lower total cost than hardware isolation modules. However, wireless physiological sensor devices sometimes have issues with latency and jitter that may make the wireless physiological sensor devices unsuitable for applications like SAO in which communication between physiological sensors is required.

### SUMMARY

Aspects of the disclosure are directed to a medical device that includes an internal wireless communication bus. The medical device comprises a first physiological sensor device comprising a first radio. The medical device further comprises a patient monitor device comprising a second radio. The medical device is configured to establish an internal wireless communication between the first radio and the second radio using the internal wireless communication bus.

In another aspect, a medical device that includes an internal wireless communication bus, the medical device comprises a first physiological sensor device comprising a first radio; and a second physiological sensor device comprising a second radio. The medical device is configured to establish a first internal wireless communication between the first radio and the second radio using the internal wireless communication bus.

In another aspect, a method is provided for implementing a wireless communication interface for a medical device. A first wireless communication is established between a first radio in the medical device and a patient monitor device. A second wireless communication is established between a second radio in the medical device and the patient monitor device. A third wireless communication is established between the first radio and the second radio using a low latency communication channel. First physiological data is transferred from the first radio to the second radio using the low latency communication channel.

In another aspect, a method is provided for improving performance for one or more physiological sensors in a medical device. A wireless communication is established between a first radio in a first physiological sensor and a second radio in a second physiological sensor in the medical device. First physiological data is obtained at the first physiological sensor. The first physiological data is transmitted from the first radio to the second radio via the wireless communication. The first physiological data is received at the second radio. Second physiological data is obtained at the second physiological sensor. The second physiological data is analyzed along with the first physiological data using multi-sensor signal processing to improve performance of the second physiological sensor.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system which includes a wireless communication bus.

FIG. 2 shows example components of a medical device for the system of FIG. 1.

FIG. 3 shows a flowchart for a method of improving the measurement of physiological data for the medical device of FIG. 2.

FIG. 4 shows a flowchart for a method of improving the measurement of physiological data for physiological sensor devices of FIG. 1.

### DETAILED DESCRIPTION

The present disclosure is directed to example systems and methods for providing a low latency and/or low jitter wireless communication bus for a medical device. In some examples, the medical device includes a plurality of physiological sensor devices. Each physiological sensor device includes a radio that has a plurality of wireless communication channels. At least one of the wireless communication channels in each radio is a low latency, low jitter communication channel.

Such a configuration can be advantageous in that the radios themselves can serve as a wireless communication bus. In addition, in some embodiments, the radios provide electrical isolation for the medical device and also permit wireless data communication between the physiological sensor devices in the medical device.

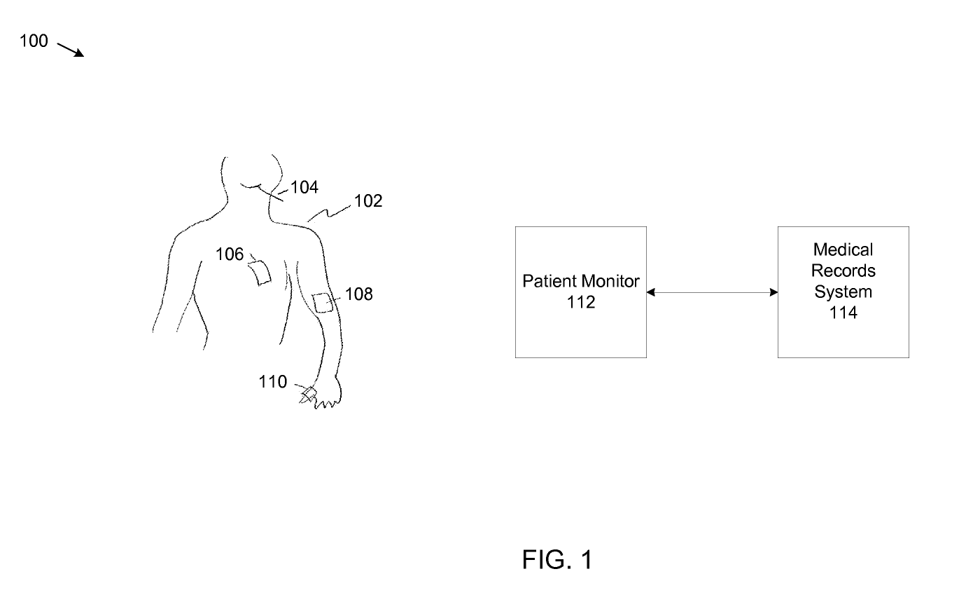

FIG. 1 shows an example system 100 in which a wireless communication bus may be used. The example system 100 includes a patient 102, a patient monitor device 112 and an electronic medical records (EMR) system 114. This disclosure uses EMR to refer to EMR and electronic health records (EHR) systems, alternatively.

A plurality of physiological sensor devices are shown as attached to the patient 102. The example physiological sensor devices include a thermometer 104, an ECG sensor 106, a non-invasive blood pressure (NIBP) sensor 108 and a SpO2 sensor 110. Other examples of physiological sensor devices are possible. One or more of the physiological sensor devices 104, 106, 108 and 110 and the patient monitor device 112 may include a radio for wireless communications.

The example patient monitor 112 receives physiological data from one or more of the physiological sensors 104, 106, 108 and 110 and forwards the physiological data to the EMR system 114. In addition, the physiological data may be displayed on the patient monitor 112. An example of a patient monitor device is the Connex® Vital Signs Monitor from Welch Allyn, Inc. of Skaneateles Falls, N.Y.

In certain medical applications, there may be a need for one or more sensor devices to communicate with each other, in addition to communicating with a patient monitor device. For example, if a patient's blood pressure is taken in a noisy environment, for example in an ambulance, a helicopter, etc., pressure pulses due to noise (e.g., rotor chop or a bumpy road) may make it difficult to detect heart beats and consequently make it difficult to properly determine blood pressure.

When sensor information from an ECG sensor is used to provide electrical heart beat information, the electrical heart beat information may be used to isolate cardiogenic pressure pulses from pressure pulses due to noise, as will be explained in detail later herein. This isolation is typically accomplished by correlating electrical signals from a patient's heart against pressure pulses detected by a blood pressure sensor.

SAO is an example of a medical application in which electrical heart beat information is correlated with pressure readings to isolate the cardiogenic pressure pulses from the noise pressure pulses. Knowing pressure pulses that are cardiogenic allows an accurate measurement of blood pressure in the presence on noise.

In medical applications involving coordination of data from a plurality of sensor devices, it can be important for communications between sensor devices to have low latency and low jitter. Latency involves a time delay for transmission of data. Jitter is a variation in latency. The requirement for low latency and low jitter may vary depending on different applications. In one example application where total system latency is less than 35 milliseconds, a radio transmission latency of the total latency may then be limited to 10 milliseconds.

A communication channel with latency guaranteed to be less than a certain value may need to have jitter be less than the certain value as well. Therefore, when a communication channel has low latency, it also has low jitter. Excessive latency may cause the data to arrive too late, where excessive jitter may, for high packet rates, cause out-of-order delivery of packets. Jitter may also cause a loss of correlation between sensors. In some cases, a system may compensate for a constant or near-constant latency by, for example, delaying a correlation function by the amount of the latency. In this example, error is introduced in the correlation function output when the system exhibits jitter.

In a medical application such as SAO, both an ECG sensor, for example ECG physiological sensor device 106 and an NIBP sensor device, for example NIBP physiological sensor device 108, are attached to a patient 102. An electrical signal in the patient's heart causes the heart to contract. The contraction creates a pressure pulse in arteries of the patient. When the ECG sensor 106 measures the electrical signal in the patient's heart, the ECG sensor 106 sends a status signal to the NIBP sensor 108. In examples, the electrical signal may correspond to R-wave peak detection at the ECG sensor 106.

The status signal alerts the NIBP sensor that an electrical signal has been detected by the ECG sensor 106. Because of the causal relationship between the electrical and pressure signals, the pressure pulse can be isolated from among the noise pressure pulses using correlation algorithms. Other algorithms are possible to be used for the isolation.

For example, when an ECG sensor 106 measures an electrical signal in the heart, a blood pressure pulse is expected in a certain time window. Therefore, the NIBP sensor 108 can ignore any pressure pulses that occur outside of that time window from when the status signal is received from the ECG sensor 106. In one example medical application, when a surgeon inserts an intra-aortic balloon pump, an indication of detection of an electrical pulse may need to occur within 35 milliseconds. Other medical applications may require different maximum latencies. Analysis of signals from multiple sensors to improve the performance of a system to make a specific measurement is generally referred to as multi-sensor signal processing.

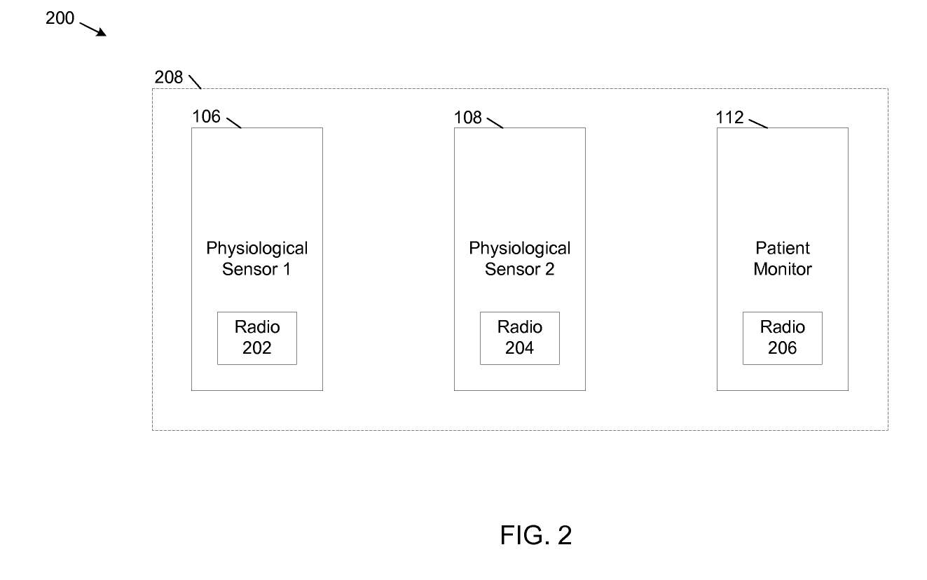

FIG. 2 shows an example system 200 in which multiple sensor devices may communicate with low latency and low jitter. The example system 200 includes physiological sensor devices 106 and 108 and patient monitor 112.

As discussed, in this example, physiological sensor device 106 is an ECG sensor and physiological sensor device 108 is a NIBP sensor device. Physiological sensor devices 106 and 108 are wireless devices and include radios 202 and 204, respectively. Patient monitor 112 includes radio 206. In the example system 200, radios 202, 204 and 206 support at least one low latency and/or low jitter channel.

A deterministic channel access protocol can support low latency, as can a dedicated channel access protocol. For one implementation, in a slotted Aloha access protocol, guaranteed time slots may allow a deterministic latency. This may be inefficient when a source (e.g., a patient's heart) operates asynchronous to the access protocol. For example, if one slot per second that matches a heart rate of 60 beats per minute is allowed, then the latency is less than one second, but this may not meet the system performance requirement. If 50 slots per second are allowed, then a transmission latency may be guaranteed to be less than 20 milliseconds. 49 slots of the total 50 slots may be wasted.

In the example system 200, the physiological sensor devices 106 and 108 and the patient monitor 112 are contained in one physical enclosure 208. Because all three devices include a radio, the wireless communication between devices 106, 108, 112 occurs via an internal wireless communication bus, embedded in the physical enclosure 208, comprising at least two of the radios. The wireless communication between devices 106, 108, 112 is an internal wireless communication.

In another example, it is possible to remove one or more of the three devices and use the removed device as a wireless sensor, whereupon the internal wireless communication bus becomes an external wireless communication bus and the wireless communication between the removed device and the remaining devices becomes an external wireless communication. For example, physiological sensor device 108 may be removed from the physical enclosure 208 and still function as a wireless sensor device.

The wireless communication between the physiological sensor device 108 and the physiological sensor devices 106 and/or the patient monitor 112 becomes an external wireless communication. An example of a medical device that has multiple physiological sensors and a patient monitor in one physical enclosure is a Propaq® patient monitor manufactured by Welch Allyn, Inc. of Skaneateles Falls, N.Y.

In the example system 200, the ECG sensor 106 establishes a wireless communication with patient monitor 112 and sends ECG data to patient monitor 112. The NIBP sensor 108 also establishes a wireless communication with patient monitor 112 and sends blood pressure data to patient monitor 112.

When the patient monitor 112 determines that communications have been established with both the ECG sensor device 106 and the NIBP sensor device 108, if an application layer on the patient monitor 112 determines that a medical application like SAO is being implemented, the patient monitor 112 may send instructions to ECG sensor device 106 to establish a low latency communication between radio 202 on the ECG sensor device 106 and radio 204 on the NIBP sensor device 108.

Alternatively, the patient monitor 112 may send instructions to NIBP sensor device 108 to establish the low latency communication with the ECG sensor device 106. The low latency wireless communication between the ECG sensor device 106 and the NIBP sensor device 108 is on a different communication channel than the wireless communication between the ECG sensor device 106 and patient monitor 112 and the wireless communication between the NIBP sensor device 108 and patient monitor 112.

In one embodiment, patient monitor 112 may relay signals between ECG sensor device 106 and NIBP sensor device 108. Patient monitor 112 services all sensor communications in a restricted time. In another embodiment, radio 206 may be configured to relay signals between ECG sensor device 106 and NIBP sensor device 108 without actually sending the signals to patient monitor 112.

In applications such as SAO, heart beat data from an ECG sensor may need to be sent to a NIBP sensor device with low jitter and with latency smaller than a beat-to-beat interval. The smaller the jitter is, the easier it is to correlate detected pressure pulses to heart beats and reject noise pressure pulses.

In a synchronized cardioversion, if a defibrillation pulse occurs during the refractory period of a cardiac cycle, then a ventricular fibrillation may be induced. Intra-aortic balloon pumps are inflated at the beginning of diastole. Current American National Standard AAMI EC13 requires that an ECG synchronization pulse occur within 35 milliseconds of the peak of the R-wave to support these types of applications.

In these examples, radios 202, 204 and 206 may be ultra-wide band radios. Radios 202, 204 and 206 may use a proprietary communication protocol to provide both low latency and low jitter suitable for a medical application such as SAO, synchronized cardioversion, and insertion in intra-aortic balloon pumps.

The low latency wireless communication between radio 202 and radio 204 comprises an internal wireless communication bus. When the low latency wireless communication is established, data and status information may be transferred from the ECG sensor device 106 and the NIBP sensor device 108 with low latency and low jitter.

Another way to coordinate data between physiological sensors is to use time stamping. For example, when the ECG sensor device 106 detects an R-wave peak corresponding to a heartbeat, a status signal that the ECG sensor device 106 sends to the NIBP sensor device 108 includes a time stamp. When the NIBP sensor device 108 receives the status signal, the NIBP sensor device 108 can determine whether any pressure pulses the NIBP sensor device 108 detects have occurred within a fixed latency time window. Clocks on the ECG sensor device 106 and the NIBP sensor device 108 may be synchronized for the use of time stamping.

A low latency wireless communication channel may also be used to synchronize data from physiological sensor devices when the physiological sensor devices are attached to the same patient but are not part of the same medical device. In one example, an ECG sensor device, for example ECG sensor device 106 and a NIBP sensor device, for example the NIBP sensor device 108, may both include radios and proximity detectors. When the proximity detectors determine that a distance between the ECG sensor device 106 and the NIBP sensor device 108 are within a first predetermined threshold, a wireless communication is established between the ECG sensor device 106 and the NIBP sensor device 108. In examples, the wireless communication may be established by a wireless communication protocol such as Bluetooth or Zigbee.

Once a wireless communication is established, a determination may be made as to whether the ECG sensor device 106 and the NIBP sensor device 108 are attached to the same patient. In one example, when the proximity detectors determine that a distance between the sensor devices is within a second predetermined threshold, lower than the first predetermined threshold for establishing a wireless communication, a determination is made that the sensor devices are attached to the same patient. In another example, the ECG sensor device 106 and the NIBP sensor device 108 may each also have a wireless communication to a patient monitor device, for example patient monitor 112.

The wireless communication of each wireless sensor to the patient monitor device may be verified. In examples, verification may be done through manual confirmation. The verification may also be done by correlation of physiological data.

Once the ECG sensor device 106 and the NIBP sensor device 108 have a verified communication to the patient monitor 112, they may obtain a patient ID from the patient monitor 112. In an example, when the ECG sensor device 106 is attached to the patient and the ECG sensor device 106 detects proximity of the patient monitor 112, the ECG sensor device 106 may initiate and verify communication to the patient monitor 112 if a range between the ECG sensor device 106 and the patient monitor 112 is within a limit. Alternately, the ECG sensor device 106 may initiate a communication and then the patient monitor 112 may prompt a clinician to manually confirm the communication. In another example, when the ECG sensor device 106 is attached to a patient and the communication is verified, and when the NIBP sensor device 108 is subsequently attached to the patient, the ECG sensor device 106 and the NIBP sensor device 108 may exchange physiological data after detecting the sensor devices 106, 108 are in range of each other. The exchange of physiological data between the ECG sensor device 106 and the NIBP sensor device 108 provides an additional method for verifying the communication is to the same patient.

For example, the ECG sensor device 106 may send R-wave peak detection data to the NIBP sensor device 108. The R-wave peak detection data is based on evaluating the peak in the QRS complex of the cardiac electrical rhythm that is detected at the ECG sensor device 106. When the NIBP sensor device 108 correlates R-wave intervals from pressure pulses measured at the NIBP sensor device 108 with the R-wave received from the ECG sensor device 106, the NIBP sensor device 108 may make a determination that the ECG sensor device 106 and the NIBP sensor device 108 are attached to the same patient and therefore may be assumed they are attached to the same patient monitor 112.

The ECG sensor device 106 and the NIBP sensor device 108 may obtain a patient ID from the patient monitor 112. In another example where there is no patient monitor, one sensor device, for example the NIBP sensor device 108 may obtain a patient ID from a second sensor device, for example the ECG sensor device 106, which is provided the patient ID when the ECG sensor device 106 is provisioned for use on the patient.

When a determination is made that the ECG sensor device 106 and the NIBP sensor device 108 are attached to the same patient, a new low jitter wireless communication may be established between the ECG sensor device 106 and the NIBP sensor device 108. In this example, establishing the new low jitter communication may depend on whether the NIBP sensor device 108 implements SAO. The communication protocol on the standard channel may communicate this information. Alternately, a low jitter communication channel may be established. The sensor devices 106, 108 determine if a SAO is required. If a SAO is not required, the low jitter communication channel may be disabled.

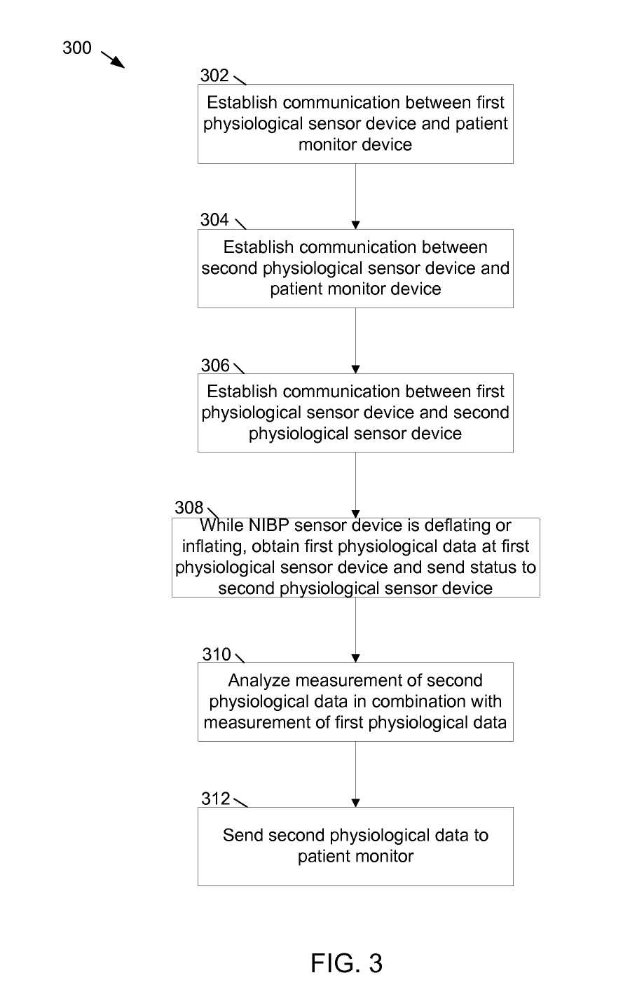

FIG. 3 shows an example flowchart of a method 300 for using a wireless communication bus to improve the measurement of physiological data in a medical device. For the method 300, the medical device includes two physiological sensor devices, for example ECG sensor device 106 and NIBP sensor device 108. Each physiological sensor device includes a radio (for example radios 202 and 204) that comprises part of a wireless communication bus. Because the communication bus is wireless and provides electrical isolation, no separate isolation of signals, for example using optocouplers, may be needed to accomplish the desired isolation.

At operation 302, a wireless communication is established between a first physiological sensor device in the medical device, for example ECG sensor device 106, and a patient monitor device, for example patient monitor 112. The communication is established when a proximity detector in the first physiological sensor device determines that the distance between the first physiological sensor device and the patient monitor is within a predetermined threshold. The communication is established between radio 202 in the ECG sensor device 106 and radio 206 in the patient monitor 112. Radios 202 and 206 typically include a plurality of communication channels. The communication is typically made on a standard communication channel that may or may not be a low latency communication channel.

At operation 304, a wireless communication is established between a second physiological sensor device, for example NIBP sensor device 108, and the patient monitor device. The communication is established when a proximity detector in the second physiological sensor device determines that the distance between the second physiological sensor device and the patient monitor is within the predetermined threshold.

Because the first physiological sensor device and the second physiological sensor device are both physically located in the same medical device, the wireless communication between the second physiological sensor device and the patient monitor typically occurs soon after the wireless communication between the first physiological sensor device and the patient monitor device occurs. The communication is established between radio 204 in the NIBP sensor device 108 and radio 206 in the patient monitor 112. The communication is typically made on a standard communication channel that may or may not be a low latency communication channel.

At operation 306 a wireless communication is established between the first physiological sensor device and the second physiological sensor device. In examples, when the patient monitor determines that the medical device includes both an ECG sensor device and an NIBP sensor device and that the medical device is running an application such as SAO, in which a measurement of physiological data at the NIBP sensor may be synchronized with physiological data from the ECG sensor, the patient monitor 112 sends a message to the radio 202 of the ECG sensor device 106 instructing the ECG sensor device 106 to establish the wireless communication with radio 204 of the NIBP sensor device 108.

At operation 308, while the NIBP sensor device 108 is deflating or inflating, physiological data from the first physiological sensor device is obtained and status is sent to the second physiological sensor device. For example for SAO, when the ECG sensor device 106 determines that R-wave peak detection has occurred, a message indicating that R-wave peak detection has occurred is sent from radio 202 of the ECG sensor device 106 to radio 204 of the NIBP sensor device 108. In examples, actual physiological data from the R-wave peak detection may also be sent from radio 202 to radio 204.

At operation 310, the measurement of the R-wave peak detection at the ECG sensor device 106 is analyzed in combination with a measurement of a pressure pulses at the NIBP sensor device 108. When the NIBP sensor device 108 receives the message at operation 308 indicating that R-wave peak detection has occurred, the R-wave peak and prior R-wave peaks are correlated against the pressure data detected by NIBP sensor device 108. The correlation shows a maximum for pressure peaks that matches the R-R intervals from ECG and allows detection of pressure pulses that are due to cardiogenic sources. In this manner, the measurement of the R-wave peak detection at the ECG sensor device 106 correlates with the measurement of blood pressure at the NIBP sensor device 108.

At operation 312, the NIBP sensor device 108 calculates a blood pressure for the patient and sends the calculated blood pressure to the patient monitor 112.

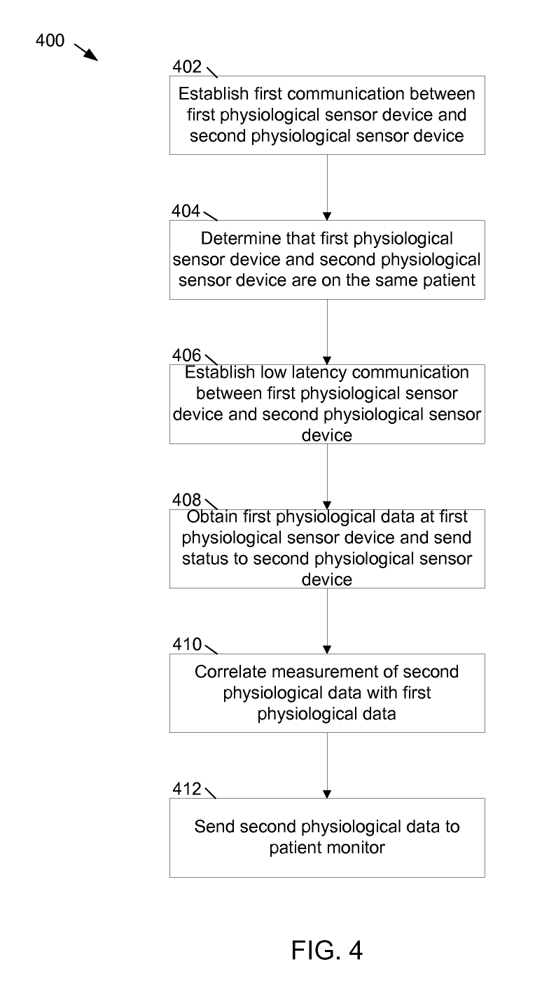

FIG. 4 shows an example flowchart of a method 400 for using a wireless communication to correlate physiological data between two physiological sensors when the two physiological sensors are on the same patient but are not part of the same medical device. For the method 400, each of the two physiological sensors includes radios and proximity detectors. For the method 400, one physiological sensor is an ECG sensor device, for example ECG sensor device 106 and a second physiological sensor is a NIBP sensor device, for example NIBP sensor device 108.

At operation 402, a wireless communication is established between the two physiological sensors. In examples, the wireless communication may be established through a standard Bluetooth protocol. In other examples, the wireless communication may be established when the proximity detectors on the ECG sensor device 106 and the NIBP sensor device 108 determine that the distance between the ECG sensor device 106 and the NIBP sensor device 108 is within a predetermined threshold.

In one example, the Bluetooth LE Find Me or the Bluetooth LE Proximity profile may be used to determine when the distance between the ECG sensor device 106 and the NIBP sensor device 108 is within a predetermined threshold. Other examples of establishing the wireless communication between the ECG sensor device 106 and the NIBP sensor device 108 are possible. In one example, the wireless communication has a maximum latency of about 10 milleseconds. Other example maximum latency is possible.

At operation 404, the ECG sensor device 106 and the NIBP sensor device 108 determine that they are physically attached to the same patient. In one example, a determination is made that the sensor devices are attached to the same patient when the proximity detectors on the ECG sensor device 106 and the NIBP sensor device 108 determine that the distance between the ECG sensor device 106 and the NIBP sensor device 108 is within a predetermined threshold. In another example, the ECG sensor device 106 and the NIBP sensor device 108 may separately obtain a patient ID from a patient monitor device, for example patient monitor 112. When the ECG sensor device 106 and the NIBP sensor device 108 make a determination that the patient ID is the same, the ECG sensor device 106 and the NIBP sensor device 108 determine that they are physically attached to the same person.

In yet another example, the ECG sensor device 106 may send R-wave peak detection data to the NIBP sensor device 108. The NIBP sensor device 108 may compare the R-wave peak detection data to intervals of R-wave data obtained on the NIBP sensor device 108. When there is a correlation of the R-wave data, a determination is made that the ECG sensor device 106 and the NIBP sensor device 108 are attached to the same person. Other examples of determining that the ECG sensor device 106 and the NIBP sensor device are attached to the same patient are possible.

At operation 406, when a determination is made that the ECG sensor device 106 and the NIBP sensor device 108 are attached to the same person, a low latency, low jitter communication is established between the ECG sensor device 106 and the NIBP sensor device 108.

At operation 408 after the low latency communication is established, physiological data from the first physiological sensor is obtained and status is sent to the second physiological sensor. For example for SAO, when the ECG sensor device 106 determines that R-wave peak detection has occurred, a message indicating that R-wave peak detection has occurred is sent from radio 202 of the ECG sensor device 106 to radio 204 of the NIBP sensor device 108. In examples, actual physiological data from the R-wave peak detection may also be sent from radio 202 to radio 204.

At operation 410, the measurement of the R-wave peak detection at the ECG sensor device 106 is correlated with a measurement of a pressure pulse at the NIBP sensor device 108. When the NIBP sensor device 108 receives the message at operation 408 indicating that R-wave peak detection has occurred, the R-wave peak and prior R-wave peaks are correlated against the pressure data detected by NIBP sensor device 108. The correlation shows a maximum for pressure peaks that matches the R-R intervals from ECG and allows detection of pressure pulses that are due to cardiogenic sources. In this manner, the measurement of the R-wave peak detection at the ECG sensor device 106 correlates the measurement of blood pressure at the NIBP sensor device 108.

At operation 412, the NIBP sensor device 108 calculates a blood pressure for the patient and sends the calculated blood pressure to the patient monitor 112. In examples where there is no patient monitor, the NIBP sensor device 108 may send data directly to an EMR system, to a clinician device such as a personal digital assistant (PDA) or smartphone, and/or may display the data on a local display.

A physiological sensor, patient monitor and EMR system are computing devices and typically include at least one processing unit, system memory and a power source. Depending on the exact configuration and type of computing device, the system memory may be physical memory, such as volatile memory (such as RAM), non-volatile memory (such as ROM, flash memory, etc.) or some combination of the two. System memory typically includes an embedded operating system suitable for controlling the operation of the sensor device. The system memory may also include one or more software applications and may include program data.

The various embodiments described above are provided by way of illustration only and should not be construed to limiting. Various modifications and changes that may be made to the embodiments described above without departing from the true spirit and scope of the disclosure.

What is claimed is:

1. A medical device that includes an internal wireless communication bus, the medical device comprising:
a first physiological sensor device comprising a first radio; and
a patient monitor device comprising a second radio,
wherein, the medical device is configured to establish an internal wireless communication between the first radio and the second radio using the internal wireless communication bus.

2. The medical device of claim 1, wherein the first radio further comprises a plurality of communication channels, at least one communication channel on the first radio being a low latency communication channel, wherein the second radio further comprises a plurality of communication channels, at least one communication channel on the second radio being a low latency communication channel and wherein the internal wireless communication is established on a low latency communication channel of the first radio and the second radio.

3. The medical device of claim 1, wherein the first and second radios each are configured to provide proximity detection.

4. The medical device of claim 3, wherein the internal wireless communication is established when the first radio is within a proximity of the patient monitor device.

5. The medical device of claim 1, wherein the first physiological sensor device is removed from the medical device and functions as a wireless physiological sensor device.

6. The medical device of claim 5, wherein the medical device is further configured to establish an external wireless communication between the first physiological sensor device and the patient monitor device.

7. The medical device of claim 6, wherein the first physiological sensor device and the patient monitor device each include a proximity detection device, the external wireless communication being established when the first physiological sensor device is within a proximity of the patient monitor device.

8. A medical device that includes an internal wireless communication bus, the medical device comprising:
a first physiological sensor device comprising a first radio; and
a second physiological sensor device comprising a second radio,
wherein, the medical device is configured to establish a first internal wireless communication between the first radio and the second radio using the internal wireless communication bus.

9. The medical device of claim 8, wherein the first radio further comprises a plurality of communication channels, at least one communication channel on the first radio being a low latency communication channel, wherein the second radio further comprises a plurality of communication channels, at least one communication channel on the second radio being a low latency communication channel and wherein the first internal wireless communication is established on a low latency communication channel of the first radio and the second radio.

10. The medical device of claim 8, further comprising a patient monitor device and a third radio, wherein the medical device is further configured to establish a second internal wireless communication between the first physiological sensor device and the patient monitor device.

11. The medical device of claim 10, wherein the medical device establishes the second internal wireless communication after receiving a message from the patient monitor device.

12. The medical device of claim 8, wherein a measurement of physiological data from the second physiological sensor device is analyzed in combination with information obtained from the first physiological sensor device via the internal wireless communication bus.

13. The medical device of claim 8, wherein the first physiological sensor device is removed from the medical device and functions as a wireless physiological sensor device.

14. The medical device of claim 13, further comprising a patient monitor device and a third radio, wherein the medical device is further configured to establish an external wireless communication between the first physiological sensor device and the patient monitor device.

15. A method of implementing a wireless communication interface for a medical device, the method comprising:
establishing a first wireless communication between a first radio in the medical device and a patient monitor device;
establishing a second wireless communication between a second radio in the medical device and the patient monitor device;
establishing a third wireless communication between the first radio and the second radio using a low latency communication channel; and
transferring first physiological data from the first radio to the second radio using the low latency communication channel.

16. The method of claim 15, further comprising:
measuring second physiological data at the medical device, the measurement of the second physiological data being correlated with a measurement of the first physiological data at the second radio.

17. The method of claim 16, further comprising:
improving performance of the measurement of the second physiological data by correlation of the measurement of the second physiological data with the first physiological data.

18. The method of claim 15, wherein establishing the first wireless communication further comprises determining that a proximity between the medical device and the patient monitor device is within a predetermined threshold and wherein establishing the second wireless communication further comprises determining that the proximity between the medical device and the patient monitor device is within the predetermined threshold.

19. A method for improving performance for one or more physiological sensors in a medical device, the method comprising:
establishing a wireless communication between a first radio in a first physiological sensor and a second radio in a second physiological sensor in the medical device;
obtaining first physiological data at the first physiological sensor;
transmitting the first physiological data from the first radio to the second radio via the wireless communication;
receiving the first physiological data at the second radio;
obtaining second physiological data at the second physiological sensor; and
analyzing the second physiological data along with the first physiological data using multi-sensor signal processing to improve performance of the second physiological sensor.

20. The method of claim 19, further comprising:
sending a message from the first radio to the second radio, the message including the first physiological data and a time stamp indicating when the first physiological data is obtained.

21. The method of claim 19, wherein the wireless communication between the first radio and the second radio is a low latency communication.

22. The method of claim 21, wherein the wireless communication has a maximum latency of about 10 milliseconds.

23. The method of claim 19, wherein the wireless communication between the first radio and the second radio is a low jitter communication.
